(19) United States
(12) Patent Application Publication
(10) Pub. No.: US 2026/0099715 A1
(43) Pub. Date: Apr. 9, 2026

(54) SYSTEM AND METHOD FOR FLOWCHART-GUIDED DIALOGUE LEVERAGING LARGE LANGUAGE MODELS

(71) Applicant: Openstream Inc., Bridgewater, NJ (US)

(72) Inventors: Rajasekhar Tumuluri, Bridgewater, NJ (US); Zhuang Li, Glen Waverley (AU); Fatemeh Shiri, Melbourne (AU); Ghlolamreza Haffari, Wheelers Hill (AU)

(73) Assignee: Openstream Inc., Bridgewater, NJ (US)

(21) Appl. No.: 19/335,493

(22) Filed: Sep. 22, 2025

Related U.S. Application Data
(60) Provisional application No. 63/703,270, filed on Oct. 4, 2024.

(51) Int. Cl. G06N 3/088; G06N 3/0475

(52) U.S. Cl. CPC G06N 3/088; G06N 3/0475

(57) ABSTRACT

A system and method for improving the performance of large language models (LLMs) in conducting flowchart-guided dialogues. Flowcharts are integrated into a dialogue generation process, enabling the LLM to handle both structured and unstructured conversations more effectively. The dialogue system can handle user digressions from predefined dialogue paths (termed “happy paths”), where users may skip steps or switch topics during a conversation.

This application claims priority to and the benefit of U.S. Provisional Patent Application No. 63/703,270, filed Oct. 4, 2024, the entire disclosure of which is incorporated by reference herein.

### BACKGROUND

Dialogue systems have become increasingly vital in various applications, including customer support, virtual assistants, and interactive voice response systems. These systems are designed to facilitate human-computer interactions, guiding users through structured workflows and providing relevant information based on user inputs. However, traditional approaches to dialogue management often rely on fixed rules and finite-state machines, which can limit the flexibility and adaptability of the system.

Flowcharts are commonly employed in dialogue systems to outline expected conversation paths—referred to as “happy paths.” These paths provide a structured guide for interactions, enabling the system to respond to user queries based on predefined decision nodes and corresponding actions. While this approach can effectively handle straightforward interactions, it falls short in real-world scenarios where users may deviate from the expected trajectory of the conversation. Users often exhibit unpredictable behavior, such as skipping steps, changing topics, or introducing irrelevant questions, leading to what are termed “unhappy paths.”

Existing dialogue systems frequently struggle to accommodate such deviations, resulting in frustration for users and ineffective responses from the system. The inability to dynamically adjust to user inputs outside the predefined paths can lead to a poor user experience, reducing the overall effectiveness of dialogue systems. Additionally, the reliance on limited real-world dialogue datasets hampers the ability of LLMs to learn and adapt to diverse conversational scenarios, as traditional training methods often do not encompass the breadth of interactions encountered in practice.

Recent advancements in LLMs have demonstrated their potential to generate coherent and contextually relevant dialogue responses. However, the integration of flowchart-based structures into the LLM training process has not been fully explored. There exists a critical need for methods that enhance the instruction-following capabilities of LLMs while incorporating flowchart guidance, allowing them to manage both structured and unstructured dialogues effectively.

### SUMMARY

Described herein are systems and methods for a flowchart guided dialogue system which leverages large language models. In implementations, a method for generating synthetic dialogues and flowcharts for multi-turn conversations includes integrating flowchart-based dialogue structures into a large language model training process by including flowcharts in a prompt to instruct the large language model on governing dialogues between a system and a user based on the flowchart, generating synthetic flowcharts by prompting the large language model to create flowcharts structured as directed acyclic graphs with nodes representing system questions and edges representing user responses, each flowchart corresponding to a specific task scenario, post-processing generated synthetic flowcharts to reduce noise and fix structural issues, ensuring the quality and usability of the synthetic flowcharts in training, using the synthetic flowcharts to generate dialogues for happy paths and unhappy paths, enabling the system to handle deviations from one or more predefined dialogue flows, and enhancing the large language model's common sense reasoning and decision-making capabilities in managing multi-turn conversations by using one or more real and synthetic flowchart-based dialogues.

### BRIEF DESCRIPTION OF DRAWINGS

The various embodiments of the disclosure will hereinafter be described in conjunction with the appended drawings, provided to illustrate, and not to limit, the disclosure, wherein like designations denote like elements, and in which:

FIG. 1 is a block diagram of an example of a computing device and/or computer system in accordance with the embodiments of this disclosure.

FIG. 2 is a block diagram of a system and/or framework for a flowchart-guided dialogue system or large language model dialogue system (LLM-DS) in accordance with embodiments of this disclosure.

FIG. 3 is a block diagram of a system architecture for a flowchart-guided dialogue system or large language model dialogue system (LLM-DS) in accordance with embodiments of this disclosure.

FIG. 4 is an illustrative example of jumping setting in the unhappy path category in accordance with embodiments of this disclosure.

FIG. 5 is an illustrative example of skipping setting in the unhappy path category in accordance with embodiments of this disclosure.

FIG. 6 is an illustrative example of a prompt to generate synthetic flowcharts in accordance with embodiments of this disclosure.

FIG. 7 is an illustrative example of a method in accordance with embodiments of this disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for improving the performance of large language models (LLMs) in conducting flowchart-guided dialogues. The system and method integrate flowcharts into a dialogue generation system and process, enabling the LLM to handle both structured and unstructured conversations more effectively. The approach addresses common challenges in dialogue systems, such as handling user digressions from predefined dialogue paths (termed “happy paths”), where users may skip steps or switch topics during a conversation. The system and method generates and manages conversational interactions based on structured flowchart representation. The system and method focuses on generating synthetic flowcharts for prompting and fine-tuning a Large Language Model (LLM) in a multi-turn conversational Artificial intelligence (AI) environment. The system and method address the challenges associated with traditional dialogue management systems, specifically in handling deviations from predefined conversation paths.

In implementations, dialogue systems are provided which generate and manage conversational interactions based on structured flowchart representation. Synthetic flowcharts are generated for prompting and fine-tuning a LLM in a multi-turn conversational AI environment. By synthesizing flowcharts and corresponding dialogues across various domains, the system aims to enhance the adaptability and robustness of LLM-based dialogue systems. The described method not only facilitates adherence to structured dialogue paths but also empowers the system to navigate user digressions, ensuring a seamless conversational experience.

In implementations, the system and method enhances dialogue systems by handling both structured and unstructured dialogue flows, ensuring smooth conversations even when users digress from predefined paths. In implementations, the system and method enhances dialogue systems by synthesizing flowcharts and dialogues across various domains, which overcomes the scarcity of real-world training data. In implementations, the system and method enhances dialogue systems by integration of domain-specific logic that ensures that the dialogue system provides appropriate responses even when users jump between different conversation topics or skip steps.

In implementations, the system and method bridges the gap between structured flowchart guidance and the flexibility required to manage real-world conversational dynamics. By leveraging synthetic data generation and advanced training techniques, the system and method aim to produce LLMs that can engage in complex, multi-turn dialogues while accommodating the natural variations of human interactions. This can significantly improve the functionality and user experience of dialogue systems across a wide range of applications.

In implementations, the system and method provides a flowchart-guided dialogue system leveraging large language models (LLMs) to conduct flexible, multi-turn conversations. Unlike traditional finite-state machine-based dialogue managers that strictly follow flowchart paths, the system and method integrates flowcharts directly into prompts and instruction-tuning data for LLMs, thereby enabling structured dialogue adherence while supporting deviations (“unhappy paths”).

The system and method provides LLMs with flowchart-driven dialogues. The system and method incorporates flowcharts as structured prompts into LLMs, instructing the LLM to govern a dialogue between the dialogue system and the user based on flowchart logic. Each flowchart is represented as a directed acyclic graph (DAG), where nodes correspond to system states or utterances (e.g., decision prompts or actions) and edges represent user responses, determining state transitions. To enhance the instruction-following ability of the LLM, the system and method train LLMs using complex instructions that combine both flowcharts and their corresponding dialogues.

The system and method addresses the scarcity of high-quality datasets for flowchart-based dialogues for training LLMs by synthesizing diverse flowcharts across multiple domains and generating synthetic dialogues for training. This increases the size and diversity of the dataset, improving generalization.

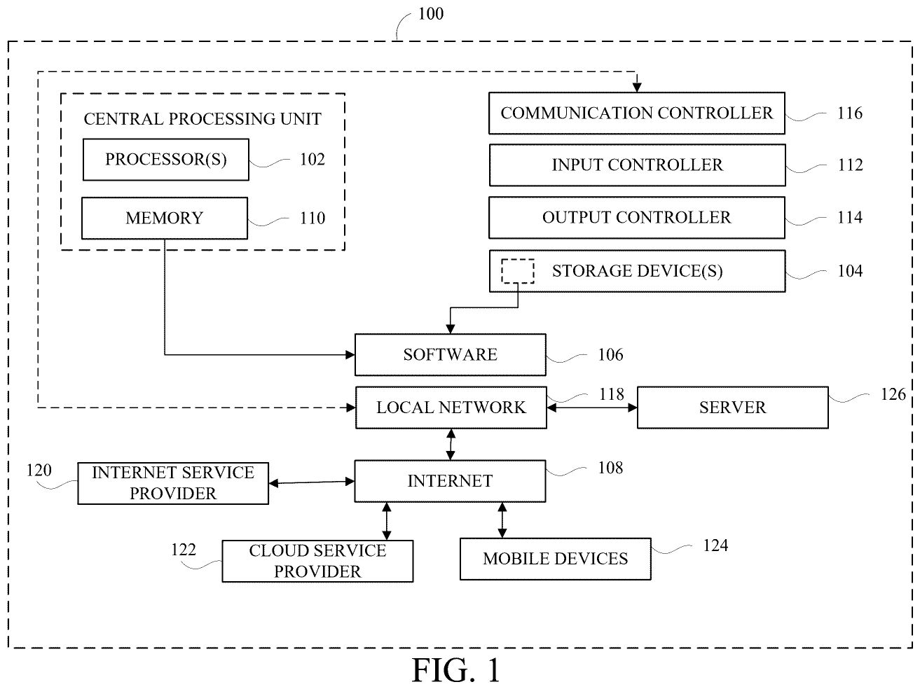

FIG. 1 is a block diagram of a system that comprises a computing device 100 to which the present disclosure may be applied according to an embodiment of the present disclosure. The system includes at least one processor 102, designed to process instructions, for example computer readable instructions (i.e., code) stored on a storage device 104. By processing instructions, processor 102 may perform the steps and functions disclosed herein. Storage device 104 may be any type of storage device, for example, but not limited to an optical storage device, a magnetic storage device, a solid-state storage device, or a non-transitory storage device. The storage device 104 may contain software 106 which may include a set of instructions (i.e., code). Alternatively, instructions may be stored in one or more remote storage devices, for example storage devices accessed over a network or the internet 108. The computing device 100 also includes an operating system and microinstruction code. The various processes and functions described herein may either be part of the microinstruction code, part of the program, or a combination thereof, which is executed via the operating system. Computing device 100 additionally may have memory 110, an input controller 112, and an output controller 114 and communication controller 116. A bus (not shown) may operatively couple components of computing device 100, including processor 102, memory 110, storage device 104, input controller 112, output controller 114, and any other devices (e.g., network controllers, sound controllers, etc.). Output controller 114 may be operatively coupled (e.g., via a wired or wireless connection) to a display device such that output controller 114 is configured to transform the display on display device (e.g., in response to modules executed). Examples of a display device include, and are not limited to a monitor, television, mobile device screen, or touch-display. Input controller 112 may be operatively coupled via a wired or wireless connection to an input device such as a mouse, keyboard, touch pad, scanner, scroll-ball, or touch-display, for example. An input device (not shown) is configured to receive input from a user and transmit the received input to the computing device 100 vial the input controller 112. The input may be provided by the user through a multi-modal interface-based computer-implemented tool. These inputs are, but not limited to, images, speech, audio, text, facial expressions, body language, touch, scanned object, and video. The communication controller 116 is coupled to a bus (not shown) and provides a two-way coupling through a network link to the internet 108 that is connected to a local network 118 and operated by an internet service provider (ISP) 120 which provides data communication services to the internet 108. A network link may provide data communication through one or more networks to other data devices. For example, a network link may provide a connection through local network 118 to a host computer, to data equipment operated by the ISP 120. A cloud service provider 122 and mobile devices 124 provides data store and transfer services to other devices through internet 108. A server 126 may transmit a requested code for an application through internet 108, ISP 120, local network 118 and communication controller 116. FIG. 1 illustrates computing device 100 with all components as separate devices for ease of identification only. Each of the components shown in FIG. 1 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be implemented as one or more servers, for example a farm of networked servers, a clustered server environment, or a cloud network of computing devices.

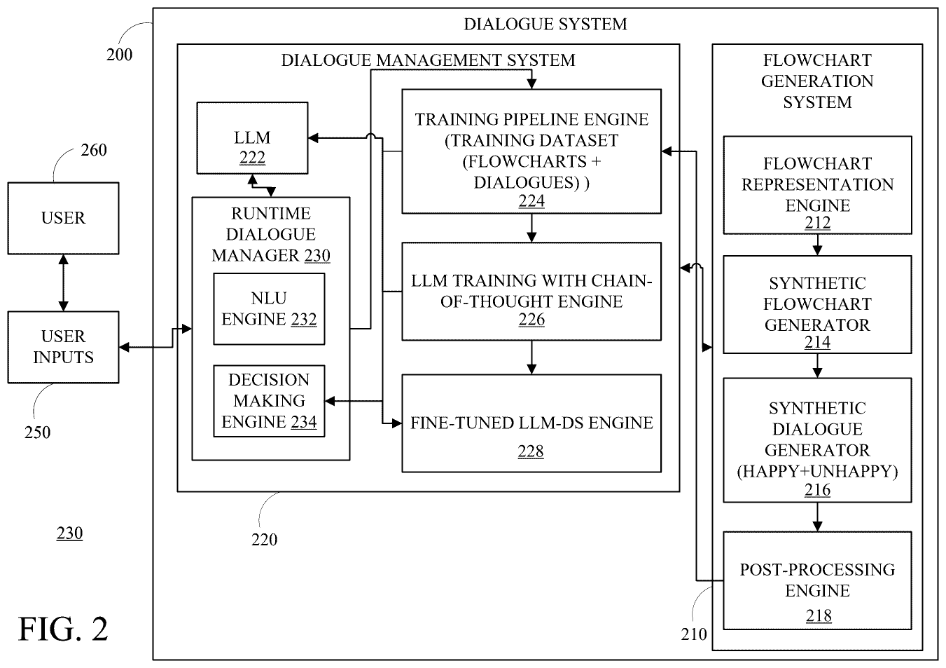

FIG. 2 is a block diagram of a flowchart-guided dialogue system or large language model dialogue system (LLM-DS 200) in accordance with embodiments of this disclosure. In implementations, the LLM-DS 200 can include a flowchart generation system 210 and a dialogue management system 220.

In implementations, the flowchart generation system 210 can generate training data for a LLM 222. The LLM 222 is a LLM-DS. The flowchart generation system 210 can include a flowchart representation engine 212, a synthetic flowchart generator 214, a synthetic dialogue generator 216, and a post-processing engine 218.

In implementations, the flowchart representation engine 212 is configured to encode and store conversational workflows in the form of directed acyclic graphs (DAGs). Each node in the DAG corresponds to a system action, prompt, or decision point, while each edge represents permissible conversational transitions based on user responses or system outcomes, leading to subsequent states. The flowchart representation engine 212 provides an intermediate semantic representation that ensures consistency between flowchart logic and dialogue execution. It also supports importing human-authored flowcharts (e.g., from domain experts) and ensures they are normalized into a machine-interpretable DAG format.

In implementations, the synthetic flowchart generator 214 is configured to generate novel task-oriented flowcharts using a LLM via prompt-driven generation. The generated flowcharts are capable of introducing alternative task sequences, optional sub-flows, parallel flows, and domain-specific branching logic beyond manually defined structures.

In implementations, the synthetic dialogue generator 216 is configured to traverse real or synthetic flowcharts and produce synthetic dialogue samples. The synthetic dialogue generator 216 generates happy path dialogues that follow the intended flowchart trajectory and unhappy path dialogues where users/user inputs deviate from expected responses. Further, the synthetic dialogue generator 216 handles intent switching across multiple flowcharts by simulating domain-specific jumping logic and produces dialogues in natural language form aligned with the semantic structure of the underlying flowchart.

In implementations, the post-processing engine 218 is configured to validate and refine the generated dialogues and flowcharts. Post-processing may include entity normalization, removal of inconsistencies, grammatical adjustments, and removal of redundant or inconsistent utterances. The post-processing engine 218 implements quality filters to discard low-confidence dialogues and ensures semantic alignment between flowcharts and generated conversations. The post-processing engine 218 is capable of incorporating manual curation inputs to further refine synthetic data.

In implementations, the dialogue management system 220 can train the LLM 222 and conduct flowchart-guided dialogue based on user inputs 250. The dialogue management system 220 can include the LLM 222, a training pipeline engine 224, a LLM training with Chain-of-Thought (CoT) engine 226, a fine-tuned LLM-DS engine 228, and a runtime dialogue manager 230.

In implementations, the training pipeline engine 224 is configured to fine-tune the LLM 222 using a hybrid dataset comprising both synthetic and real-world dialogue data. In implementations, this is provided by the flowchart generation system 210. The training pipeline engine 224 integrates flowcharts and dialogues into a complex instruction-following dataset. The training pipeline engine 224 applies a plurality of optimization objectives to improve language fluency, node-response alignment, slot-filling accuracy and robustness against deviation from expected user paths.

In implementations, the LLM training with Chain-of-Thought (CoT) engine 226 is configured to augment training with chain-of-thought (CoT) reasoning traces. The LLM training with Chain-of-Thought (CoT) engine 226 enables the LLM 222 to generate intermediate reasoning steps before producing system (e.g., the LLM-DS 200) responses and improves the system's ability to handle ambiguous or digressive user inputs by simulating explicit reasoning aligned with the underlying flowchart. The LLM training with Chain-of-Thought (CoT) engine 226 also ensures that both happy path and unhappy path dialogues are supported with transparent reasoning sequences.

In implementations, the fine-tuned LLM-DS engine 228 is configured to execute flowchart-guided dialogue with high fidelity to both natural language expectations and structured task logic. The fine-tuned LLM-DS engine 228 integrates with and/or is connected with the LLM 222 that has been fine-tuned on a hybrid corpus of real-world and synthetic dialogues generated from flowcharts. The fine-tuning process employs a multi-objective loss function that jointly optimizes (i) the fluency and coherence of natural language generation, (ii) the alignment of system outputs with flowchart nodes and transitions, and (iii) the accuracy of slot-filling for user-provided information. In certain implementations, the LLM 222 is trained in stages, beginning with structured ‘happy path’ dialogues and subsequently exposed to more complex ‘unhappy path’ deviations. This staged training strategy enhances the LLM 222 predictive capability to real-world digressions while preserving adherence to underlying flow structures. Further, the fine-tuned LLM-DS engine 228 incorporates reasoning mechanisms based on chain-of-thought (CoT) prompting, enabling the system to simulate intermediate reasoning steps for improved intent recognition and error recovery. At runtime, the fine-tuned LLM-DS engine 228 provides the dialogue manager 230 with contextually appropriate utterances, state predictions, and fallback strategies, while also leveraging confidence scoring to decide when to re-prompt, clarify, or switch flowcharts.

In implementations, the runtime dialogue manager 230 is configured to execute flowchart-guided conversations with live users (e.g., using or via user inputs 250). The runtime dialogue manager 230 detects deviations from expected user paths and applies corrective strategies such as re-prompting, suggesting clarifications or flowchart switching, interfaces with external systems (e.g., APIs or databases) to fetch information, trigger actions during the dialogue, and logs interactions for continuous feedback and retraining of the LLM 222. The runtime dialogue manager 230 supports real-time adaptation by dynamically modifying flowchart traversal strategies based on user intent and context.

In implementations, the runtime dialogue manager 230 can include, but is not limited to, a Natural Language Understanding engine (NLU engine 232) and a decision making engine 234. The NLU engine 232 is configured to interpret user inputs, extract intents, and map user utterances to corresponding flowchart edges. The decision making engine 234 is configured to apply domain-specific logic when deviations occur. The decision making engine 234 can determine whether to skip steps within the same flowchart, branch to an alternative node, or switch to a different flowchart, thereby ensuring coherent dialogue management during both expected and unexpected user behaviors.

The NLU engine 232 is configured to process live user inputs and map free-form natural language to flowchart edges, nodes, or intents. The NLU engine 232 also enables handling of unhappy paths (skips, jumps, intent switches). The NLU engine 232 is configured to (a) process user inputs expressed in free-form natural language, extract intents, entities, and contextual cues, and align them with corresponding flowchart nodes or transitions, and (b) interpret user inputs, map them to flowchart edges, and extract semantic intent and slot values necessary for maintaining dialogue state. The NLU engine 232 further supports deviation handling by interpreting user utterances that may not strictly correspond to predefined flowchart responses, thereby enabling smooth execution of both happy and unhappy path dialogues.

The decision making engine 234 applies domain-specific logic to determine whether to continue the current path, skip steps, or switch to a different flowchart. This module uses preconfigured constraints or rules to ensure coherence and consistency in dialogue flow, particularly during unhappy paths. The decision making engine 234 is configured to incorporate domain-specific logic into the dialogue generation process in order to guide the system's decision-making when managing user digressions from predefined flowchart paths. In implementations, the decision making engine 234 determines whether the system should continue along the current flowchart, skip one or more steps, branch to an alternate node, or switch to a different flowchart corresponding to a new user intent. The decision making engine 234 applies predefined domain rules, contextual constraints, or dynamic policies to ensure that conversation flow remains coherent and consistent, even when the user provides unexpected inputs. By embedding such domain-specific logic, the decision making engine 234 enables robust handling of “unhappy path” scenarios, thereby maintaining task relevance and conversational integrity during deviations. The decision making engine 234 is configured to apply domain-specific logic when deviations occur, including determining whether to skip steps, branch within the same flowchart, or switch to a different flowchart. The decision making engine 234 ensures coherent dialogue management by enforcing predefined rules or constraints during unhappy paths.

Described herein are flowcharts and dialogue paths.

### Dialogue Happy Paths

A happy path is a conversation trajectory where the user follows the intended sequence of flowchart decisions.

At dialogue turn t:

The LLM-DS 200 is at a node state sₜ, tagged with a semantic representation zᵣ^{y} (e.g., a structured question).

The LLM-DS 200 verbalizes zᵣ^{y} into natural language utterance vᵣ^{y} and presents it to the human interlocutor (i.e., user 260).

The user 260 provides (via user inputs 250) an utterance uₜ.

The user 260 then answers by

$${v}_{t}^{x} ,$$

which is then ‘understood’ by the LLM-DS 200 at the semantic level as

$${z}_{x}^{t} ,$$

which is the label of the flowchart edge eₜ outgoing sₜ to determine the next state sₜ₊₁.

The result is a trajectory

$$d := {\{ ( {s}_{t} , {e}_{t} , {z}_{t}^{y} , {v}_{t}^{y} , {z}_{t}^{x} , {v}_{t}^{x} ) \}}_{t = 1}^{T} ,$$

where sₜ is a flowchart node and eₜ is the flowchart edge connecting sₜ to sₜ₊₁.

The flowchart nodes correspond to the system utterances and determine dialogue state. The flowchart edges correspond to the user utterances and determine the transition between the states.

### Dialogue Unhappy Paths

In real-world conversations, users often deviate from predefined flowchart responses. The system and method accounts for such unhappy paths, where the user's input does not correspond to one of the expected outgoing edges from the current node.

Two types of digressions are supported, intra-flowchart jumps and inter-flowchart jumps.

In an intra-flowchart jump, the user skips intermediate steps and jumps to a non-adjacent node within the same flowchart.

In an inter-flowchart jump, the user changes intentions mid-dialogue, jumping to a node in a different flowchart (e.g., switching from “loan application” to “bill payment” in a banking domain).

In both cases, the LLM-DS 200 determines the correct next state by leveraging common sense reasoning encoded in the LLM 222 and domain-specific logic. The LLM-DS 200 then continues the conversation by adapting its trajectory accordingly.

### Chain-of-Thoughts (CoT) Training

To improve the system's ability to conduct dialogues based on flowcharts, the method and system introduces a chain-of-thoughts (CoT) training paradigm.

At each dialogue turn t:

Before producing the next utterance, the LLM-DS 200 internally generates a chain of thoughts (CoT), reasoning over the flowchart, dialogue history, and commonsense knowledge.

Based on this reasoning, the LLM-DS 200 selects the appropriate next node and generates a natural language response.

The training objective is based on negative log-likelihood minimization, where the LLM parameters θ are optimized to minimize the loss across a set of flowcharts F={F1, . . . , Fk}.

The training objective is of the form:

$$arg {min}_{θ} ℒ ( θ ) := - {\sum }_{t} log \text{?} ( \text{?} \vert \text{?} , ℱ ) + log \text{?} ( \text{?} \vert \text{?} , ℱ )$$

$$log \text{?} ( \text{?} \vert \text{?} , ℱ ) + log \text{?} ( \text{?} \vert \text{?} , ℱ )$$

$$where \text{?} := \{ ( \text{?} ) \text{?} and ℱ := \{ \text{?} \} is the set of flowcharts with individual flowcharts \text{?}$$

$$\text{?} \text{indicates text missing or illegible when filed}$$

This process allows the LLM to learn how to balance strict flowchart adherence with flexible reasoning for managing digressions.

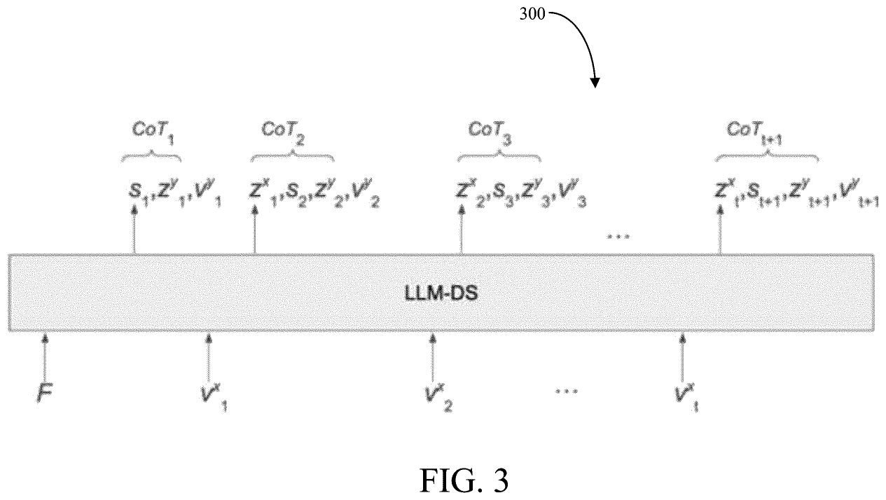

Reference is now also made to FIG. 3, which is a block diagram of a system architecture for a flowchart-guided dialogue system or large language model dialogue system (LLM-DS 300) in accordance with embodiments of this disclosure. In particular, FIG. 3 illustrates the architecture of the LLM-DS 300 and its generation process corresponding to the negative-log-likelihood training objective. At time step t, the LLM-DS 300 is at the dialogue state sₜ in which it has uttered the response vₜ^{y} based on the semantic zₜ^{y} to the human interlocutor/user. Then the user utters

$${v}_{t}^{x}$$

after which the LLM-DS 300 generates its chain of thoughts (CoT) for the next dialogue turn, consisting of

$${z}_{t}^{x} , {s}_{t + 1} , {z}_{t + 1}^{y} ,$$

followed by its response

$${v}_{t + 1}^{y}$$

to the user.

The LLM-DS 300 facilitates flexibility in dialogue management by handling both happy and unhappy paths, allowing robust responses to digressions, overcomes data scarcity by synthesizing flowcharts and dialogues across multiple domains, employs LLM-encoded knowledge through commonsense reasoning to determine appropriate responses beyond strict flowchart logic, and enhanced training via CoT, where CoT reasoning improves the training process and thereby decision-making for complex dialogue trajectories.

### Synthetic Flowchart and Dialogue Generation

Given the limited number of real-world flowcharts, the method and system generates synthetic flowcharts using advanced LLMs such as GPT-4. These flowcharts are constructed as DAGs with well-defined node labels (system questions) and edge labels (user responses).

The LLM-DS further synthesizes dialogues for both:

Happy paths: Enumerating all valid paths in a flowchart and verbalizing them into dialogues.

Unhappy paths: Introducing skip connections or inter-flowchart jumps to simulate digressions.

The synthetic data is then post-processed to reduce noise, ensuring high quality for training. Low-quality flowcharts are either corrected or discarded.

### Synthetic Data Generation

### Generating Synthetic Dialogues

One of the key bottlenecks in enabling large language model (LLM)-based dialogue agents to effectively use flowchart knowledge is the availability of high-quality and sufficiently diverse dialogue data. To address this limitation, the method and system introduces a synthetic data generation framework that leverages flowcharts to rapidly produce high-quality dialogue examples for fine-tuning LLM-based dialogue systems. The framework generates dialogues for both happy paths (i.e., predefined flowchart-guided conversations) and unhappy paths (i.e., digressions, skips, or topic jumps).

### Dialogue Generation for Happy Paths

Happy path synthetic dialogue generation aims to simulate structured interactions between a system (agent) and a user, strictly following an enumerated path in a flowchart. Each flowchart is represented by decision nodes and action nodes:

Decision nodes contain system questions, connected by user responses (e.g., “Yes”/“No”) to subsequent nodes.

Action nodes represent terminal outcomes (e.g., completing a booking or executing a transaction).

Given an extracted path from a flowchart, the LLM-DS prompts LLM to generate synthetic dialogues grounded on the path. Illustrative steps are shown in Table 1—Algorithm 1.

TABLE 1
Algorithm 1. Dialogue Generation for a Happy Path

```
$Require : r = \{ ( s \text{?} , \text{?} ) \} \text{?} : Happy path ; ℓ ( . ) returns the label$
(semantics of the utterance) of a node or edge in the
flowchart
  1. d = ∅
  2. for t ∈[1, ... , n] do
  3. [symbol]   ← LLM( [symbol] (sₜ); dₜ)
  4. [symbol]   ← LLM( [symbol] (eₜ); [symbol] , [symbol] (sₜ), dₜ)
  5. [symbol]   ← d ∪ {sₜ, eₜ, [symbol] (sₜ), [symbol] , [symbol]  (eₜ), [symbol]    }
  6. end for [symbol]
indicates data missing or illegible when filed
```

The method and system enumerates all paths in the flowchart and generates dialogues for each path by prompting an LLM. The resulting dialogues are verbalized representations of the semantic states and transitions of the flowchart, thereby covering all possible structured trajectories.

### Dialogue Generation for Unhappy Paths

In real-world applications, user behavior often diverges from the happy paths prescribed by flowcharts. To capture these variations, the method and system introduces methods to generate unhappy path dialogues, which include two principal forms of digressions: skipping steps and jumping between flowcharts.

For skipping steps, the user provides answers to questions that belong to future states in the flowchart, allowing the system to bypass intermediate questions.

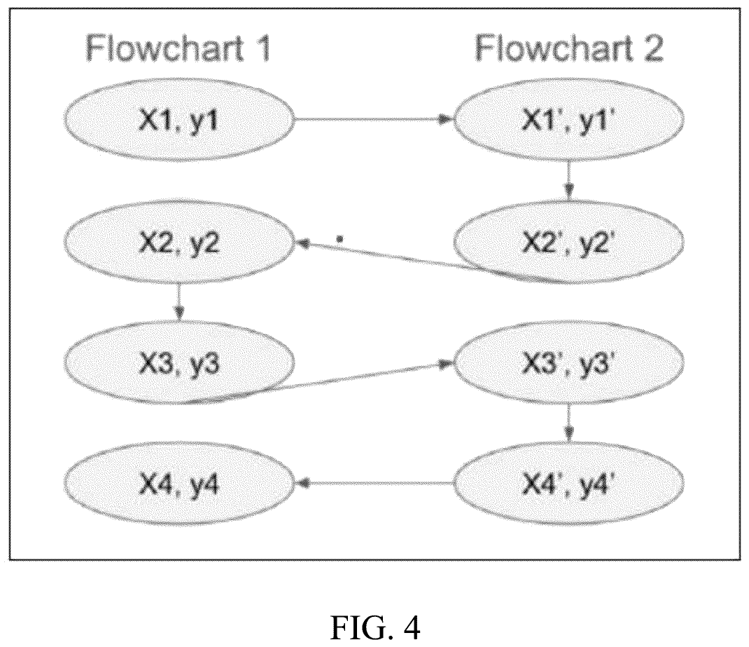

For jumping between flowcharts, the user changes intent mid-conversation (e.g., switching from loan application to bill payment). In such cases, the system must pause the current flowchart execution and resume with the new flowchart corresponding to the updated user intent. An illustrative example of the flowchart jumping is depicted in FIG. 4, which is an illustrative example of jumping setting in the unhappy path category in accordance with embodiments of this disclosure.

Table 2—Algorithm 2 provides the framework for generating synthetic dialogues corresponding to unhappy paths when users deviate from the current flowchart trajectory and switch to an alternate intention represented by another flowchart. The algorithm operates as follows:

When a user expresses a new intent during an ongoing dialogue, the system immediately transitions to the happy path of the new flowchart corresponding to the updated intention.

The execution of the current flowchart is temporarily suspended or put on hold.

TABLE 2
Algorithm 2. Generate Unhappy Paths-Jumping

Require: τₖ = {(s [symbol] e_{t,k})}ⁿₜ₌₁ [symbol] Happy paths from different flowcharts Fₖ for k ∈
[1 [symbol] K]

| | |
|---|---|
| 1. | β ← [ [symbol] , K] |
| 2. | Initialise τ [symbol] ← Ø, α[k] ← 1, ∀k∈ β |
| 3. | [symbol] ← randomly pick from β |
| 4. | whileβ is not empty do |
| 5. | if cointoss is head then |
| 6. | τ [symbol] ← τ [symbol] ∪ {(s [symbol] k, e [symbol] k)} |
| 7. | α[k] ← α[k] [symbol] 1 |
| 8. | if α[k] = n [symbol] then |
| 9. | remove k from β |
| 10. | [symbol] ← randomlypickfrom β |
| 11. | end if |
| 12. | else |
| 13. | [symbol] ← randomlypick from β |
| 14. | end if |
| 15. | end while |
| 16. | return τ [symbol] |

[symbol]

indicates data missing or illegible when filed

The determination of whether the system should transfer control immediately to the new flowchart or maintain the current flowchart in parallel depends on application-specific requirements.

In particular, domain-specific logic governs such decisions. For example, in financial services, switching away from a transaction flow may require explicit confirmation, while in customer service contexts, the system may allow immediate intent switching. Such domain logic can be incorporated into Algorithm 2 as constraints on jumping decisions, thereby ensuring that generated synthetic dialogues reflect realistic and context-sensitive behaviors.

Table 3—Algorithm 3 shows the dialogue generation for the unhappy paths generated by Algorithm 2. More specifically, lines 5-7 check whether there is a jump to generate the proper request from the user.

TABLE 3
Algorithm 3. Dialogue Generation for an Unhappy Path

Require: τ = {(s [symbol] e [symbol] )} [symbol] a mixed Unhappy path

```
  1. d = ∅
  2. for i ∈[1, ... , m] do
  3. [symbol]   ← LLM( [symbol] (s [symbol]  ); dₜ)
  4.  ${v}_{i}^{x} ← LLM ( ℓ ( {e}_{t , k}^{i} ) , {v}_{i}^{y} , ℓ ( {s}_{t , k}^{i} ) , {d}_{t} )$
  5. If flowChart(τ[i]) ≠ flowChart(τ[i + 1]) then
  6.  ${v}_{i}^{x} ← {v}_{i}^{x} + LLM ( ’ can i change to ℓ ( flowChart ( τ [ i + 1 ] ) ) ? ’ )$
  7. end if
  8.  $d ← d ⋃ \{ ( {s}_{t , k}^{i} , {e}_{t , k}^{i} , ℓ ( {s}_{t , k}^{i} ) , {v}_{i}^{y} , ℓ ( {e}_{t , k}^{i} ) , {v}_{i}^{x} ) \}$
  9. end for
10. return d
```

[symbol]

indicates data missing or illegible when filed

The method and system provides algorithms to generate synthetic dialogues for these scenarios. In the case of jumps, the algorithm transitions directly to the new flowchart's happy path while deferring or discarding the current trajectory. Domain-specific rules can optionally be incorporated to determine whether to immediately switch or temporarily hold the current flowchart execution.

Skipping is modeled by augmenting dialogue trajectories with skip edges, which connect an earlier state to a future state. A decision variable, γₜ^{x}, determines whether an answer can be inferred from dialogue history. If γₜ^{x}=1, the system retrieves the answer from prior dialogue turns and skips asking the question again; otherwise, γₜ^{x}=0, and the system explicitly queries the user. This mechanism ensures that the generated dialogues reflect naturalistic user behaviors.

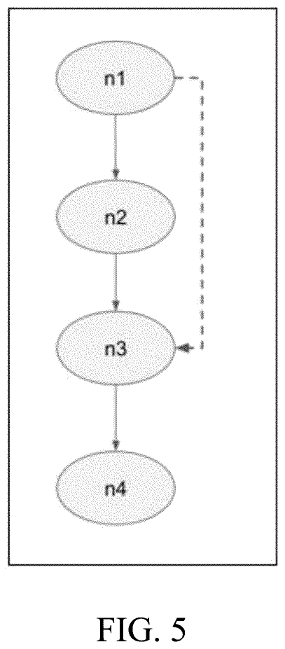

Reference is now also made to FIG. 5, which is an illustrative example of skipping setting in the unhappy path category in accordance with embodiments of this disclosure. In particular, FIG. 5 illustrates an example scenario where a flowchart path comprises four states/nodes. Suppose in the answer to the question corresponding to the state n1, the user additionally provides the answer to the question corresponding to the state n3 as well. This is shown by adding the ‘skip’ edge from n1 to n3. This skip edge means that the dialogue agents should skip the state n3 and not ask the corresponding question.

This is achieved by changing the generative dialogue process by adding a binary decision variable γₜ^{x}, showing whether the answer to the flowchart state's question can be fetched from the dialogue history. If γₜ^{x}=1, then the system produces the answer vₜ^{x} based on the history; otherwise, γₜ^{x}=0 and the system prompts the user to produce the answer vₜ^{x}. Therefore, the training log-likelihood can be rewritten as:

$$arg {min}_{θ} ℒ ( θ ) := - {\sum }_{t} \text{?} log \text{?} ( \text{?} \vert \text{?} , ℱ )$$

$$log \text{?} ( \text{?} \vert \text{?} , ℱ ) + log \text{?} ( \text{?} \vert \text{?} , ℱ )$$

$$log \text{?} ( \text{?} \vert \text{?} , ℱ ) + log \text{?} ( \text{?} \vert \text{?} , ℱ )$$

$$\text{?} \text{indicates text missing or illegible when filed}$$

The synthetic dialogue trajectory can be augmented by including the decision variable as:

$$d := {\{ ( {s}_{t} , {e}_{t} , {z}_{t}^{y} , {v}_{t}^{y} , {z}_{t}^{x} , {γ}_{t}^{x} , {v}_{t}^{x} ) \}}_{t = 1}^{T} .$$

Synthetic dialogues can be generated with skipping connections. Initially, start with a synthetic dialogue generated for happy paths or unhappy paths with jumping,

$$d := {\{ ( {s}_{t} , {e}_{t} , {z}_{t}^{y} , {v}_{t}^{y} , {z}_{t}^{x} , {γ}_{t}^{x} , {v}_{t}^{x} ) \}}_{t = 1}^{T} .$$

For each dialogue turn t, randomly decide whether to have a skip connection to a state in the history or not; this can be done by tossing a coin. In case of skip connection, randomly choose one of the states in the history sₜ<sₜ, with the constraint that there is no skip connection to sₜ previously. We then merge the user's answer with the answer,

$${v}_{{t}^{′}}^{x} ,$$

and set

$${γ}_{t}^{x} = 1.$$

Through the jumping and skipping techniques, the system and method produces synthetic dialogues that significantly improve the robustness of LLM-based dialogue systems in handling real-world deviations.

### Generating Synthetic Flowcharts

A further limitation in training flowchart-driven dialogue systems is the scarcity of diverse, high-quality flowcharts. To overcome this, the system and method synthesizes flowcharts across multiple domains using large-scale generative models (e.g., GPT-4).

Each synthetic flowchart is generated as a directed acyclic graph (DAG) consisting of nodes and edges. The nodes (states) represent semantic system questions. The edges (transitions) represent user responses that determine progression between states.

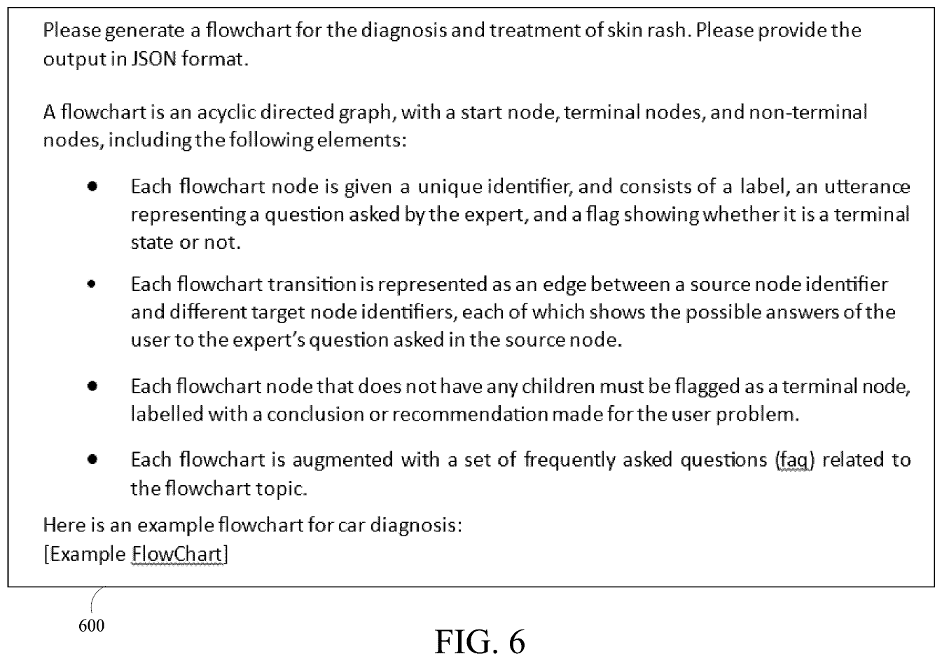

The system and method prompts the LLM to produce a wide range of task scenarios across multiple domains (e.g., medical diagnosis, banking, technical support). For each domain, a set of possible task intentions is generated, such as “diagnosis of skin rash” in healthcare or “credit card activation” in banking. The flowcharts are then generated for each scenario, ensuring diversity in structure and content. An example illustration of a prompt for generating synthetic flowcharts is shown in FIG. 6, which is an illustrative example of a prompt 600 to generate synthetic flowcharts in accordance with embodiments of this disclosure.

As described herein, the system uses flowcharts as directed acyclic graphs to define dialogue paths. Decision nodes represent system prompts, while user responses guide the conversation to other nodes. The system supports both happy paths (ideal conversations that follow a linear flow) and unhappy paths (where users deviate from the expected flow).

Since real-world data on flowchart-guided dialogues is scarce, the system and method generates synthetic flowcharts and corresponding dialogues using LLMs. These synthetic flowcharts span diverse domains and task scenarios. The system generates dialogues for both structured interactions (happy paths) and unstructured interactions (unhappy paths). The generation process is further enhanced by post-processing steps to improve the quality and relevance of the synthetic data.

The system and method provides a method for fine-tuning the LLM using both real and synthetic flowchart-guided dialogues. This training helps the LLM handle deviations from happy paths, such as skipping steps within a flowchart or switching to a different flowchart based on the user's new intention. The system uses domain-specific logic to guide the LLM's responses in these situations.

Handling Unhappy Paths: In scenarios where users deviate from the predefined flow, the system is equipped to handle two types of digressions: skipping steps within the same flowchart, and jumping to a different flowchart corresponding to a new user intention (e.g., switching topics mid-conversation).

By synthesizing a large volume of high-quality dialogues and flowcharts, the system improves the LLM's instruction-following capabilities, making it better at managing complex, multi-turn dialogues. The system is designed to be adaptable, accommodating user behaviors that deviate from expected conversational paths, thus providing a more flexible and robust dialogue experience.

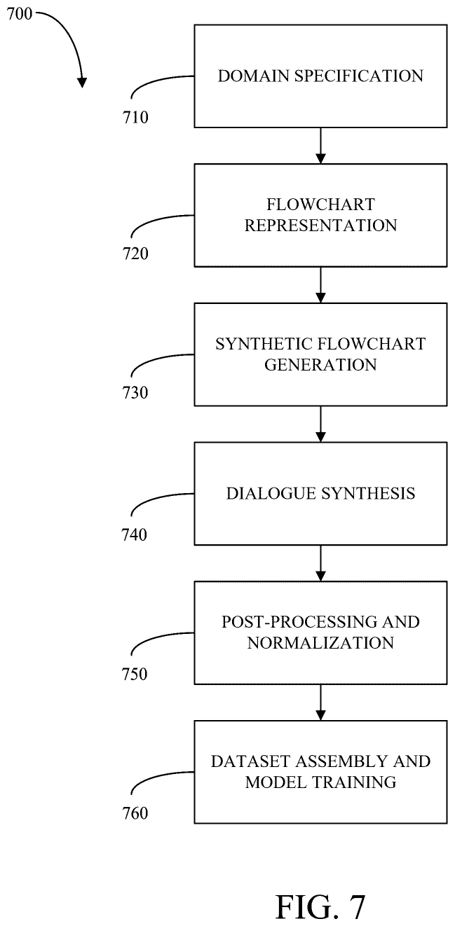

FIG. 7 is an illustrative example of a method 700 in accordance with embodiments of this disclosure.

At 710, domain specification is performed. A plurality of task domains is defined, each representing structured interactions such as information retrieval, troubleshooting, booking, or transactional services. For each domain, intents, slot definitions, and external system actions are identified and stored.

At 720, flowchart representation is performed. Dialogues within each domain are encoded as directed acyclic graphs (DAGs). Each node is annotated with metadata including a node identifier, prompt type, required information, and transition rules. Edges define permissible conversational transitions, conditioned on user inputs or system outcomes.

At 730, synthetic flowchart generation is performed. A large language model (LLM) is employed to generate synthetic flowcharts that extend the set of manually defined dialogue structures. Variants may include, but are not limited to, alternative task orderings, optional or conditional sub-flows, and domain-specific branching logic validated by a rules engine.

At 740, dialogue synthesis is performed. The system traverses flowcharts to generate synthetic dialogues. The process includes, but is not limited to: happy paths, where conversations follow an ideal, structured sequence from start to completion; unhappy paths, where conversations deviate from the expected flow, including skipped steps, out-of-order responses, interruptions, or topic switches to different domains; and multiple paraphrases of system prompts and user responses are generated to increase linguistic diversity and resilience.

At 750, post-processing and normalization is performed. The synthesized dialogues undergo automated refinement, including entity normalization, removal of contradictions, correction of grammatical inconsistencies, and filtering of incoherent samples. In some implementations, quality assurance includes classifier-based rejection of dialogues that fail to meet predefined thresholds.

At 760, dataset assembly and model training is performed. Synthetic dialogues are combined with real-world conversational data to form a unified training corpus. Each dialogue is labeled with metadata such as flowchart identifier, path classification (happy or unhappy), and slot completion status. The LLM is fine-tuned on this corpus using a multi-objective loss function balancing natural language generation quality, alignment of system outputs with flowchart nodes, and accuracy of slot filling. In certain implementations, curriculum training is employed such that the model first learns structured dialogues before being exposed to progressively more complex deviations.

Described herein is a non-limiting illustrative use case in the flight booking domain.

See Table 4 For a Happy Path, where the dialogue traverses the flowchart sequentially without deviation.

TABLE 4

∘ System: “Where would you like to fly?”
∘ User: “New York.”
∘ System: “What date would you like to travel?”
∘ User: “October 12th.”
∘ System: “Do you prefer economy or business class?”
∘ User: “Economy.”
∘ System: “A flight has been reserved for you.”

See Table 5 For a Unhappy Path.

TABLE 5

| | |
|---|---|
| ∘ | System: “Where would you like to fly?” |
| ∘ | User: “October 12th.” (date provided before |
| | destination) |
| ∘ | The Dialogue Manager detects missing information |
| | and issues recovery: |
| | System: “Understood, you want to travel on |
| | October 12th. Can you specify your |
| | destination?” |
| ∘ | Conversation resumes from the corrected node |
| | sequence. |

See Table 6 For another Unhappy Path.

TABLE 6

| | |
|---|---|
| ∘ | System: “Where would you like to fly?” |
| ∘ | User: “Actually, what's the weather in New York |
| | today?” |
| ∘ | The Dialogue Manager redirects to the weather-query |
| | flowchart, provides the requested information, and |
| | optionally offers to resume the original booking flow. |

Described is a computer-readable storage medium storing instructions that, when executed by a processor, cause the processor to perform a method for generating synthetic dialogues and flowcharts for multi-turn conversations, including integrating flowchart-based dialogue structures into a large language model training process by including flowcharts in a prompt to instruct the large language model on governing dialogues between a system and a user based on the flowchart, generating synthetic flowcharts by prompting the large language model to create flowcharts structured as directed acyclic graphs with nodes representing system questions and edges representing user responses, each flowchart corresponding to a specific task scenario, post-processing generated synthetic flowcharts to reduce noise and correct structural issues including mislabeled nodes, duplicate edges, missing terminal states, or inconsistent node-to-edge mappings. In some implementations, structural issues are considered correctable when they can be resolved by localized edits to node labels, edge labels, or state transitions without requiring regeneration of the entire flowchart. If the level of inconsistencies exceeds a predetermined threshold, such as more than a specified number of disconnected nodes, unresolved cycles in the directed acyclic graph, or semantic contradictions between decision nodes and action nodes, the flowchart is discarded and re-generated. It ensures a quality and usability of the synthetic flowcharts in training, using the synthetic flowcharts to generate dialogues for happy paths and unhappy paths, enabling the system to handle deviations from one or more predefined dialogue flows, and enhancing common sense reasoning and decision-making capabilities in the large language model to manage multi-turn conversations by using one or more real and synthetic flowchart-based dialogues.

In implementations, the generating further comprises prompting the generating to generate a diverse set of flowcharts based on specific task scenarios, where each flowchart is a directed acyclic graph composed of decision nodes associated with system questions and action nodes associated with user responses, generating a list of potential task scenarios for flowchart generation by prompting the large language model to produce domain-specific intentions, followed by manual post-processing to filter out low-quality scenarios, and post-processing generated flowcharts to fix issues and ensure logical coherence, with flowcharts being discarded and regenerated if they require significant corrections. In implementations, the synthetic flowcharts are used to generate dialogues for happy paths by: enumerating all possible paths within a flowchart, each path consisting of decision nodes connected by user responses and culminating in an action node, prompting the large language model to generate synthetic dialogues for each path, simulating ideal customer-agent interactions where the user follows a predefined flowchart sequence, and using generated dialogues to train the large language model on conducting conversations that adhere to flowchart-based instructions. In implementations, the synthetic flowcharts are used to generate dialogues for unhappy paths by: simulating deviations from a happy path within the flowchart by generating dialogues where users skip nodes or jump between different flowcharts, incorporating domain-specific logic into a dialogue generation process to guide the system's decision-making when managing user digressions from predefined flowchart paths; and training the large language model to recognize and manage these deviations, ensuring coherent conversation flow even when the user jumps between different task scenarios or skips steps within a flowchart.

Described herein is a method for improving large language models in conducting multi-turn dialogues based on flowcharts, the method includes synthesizing flowcharts by prompting a large language model to generate directed acyclic graphs with nodes representing system questions and edges representing user responses, covering diverse domains and task scenarios, enhancing a diversity of training data by generating synthetic flowcharts across multiple domains and refining them to ensure quality, using generated flowcharts to simulate happy paths and unhappy paths in dialogue, where the happy paths represent ideal, sequential dialogue flows and the unhappy paths simulate real-world deviations such as skipping steps or jumping between flowcharts or between nodes of flowcharts, and fine-tuning the large language model to manage both the happy paths and the unhappy paths based on flowchart structures, improving an ability to handle complex, real-world conversations.

Described herein is a dialogue system including a flowchart generation engine configured to synthesize flowcharts by prompting a large language model and apply post-processing to ensure a quality of generated flowcharts before use in training and dialogue generation, where synthetic flowcharts are generated as directed acyclic graphs representing dialogue structures across a plurality of domains and task scenarios, a large language model trained using both real and the synthetic flowcharts, and a dialogue manager configured to: detect user deviations from predefined happy paths and adapting a conversation by either skipping steps or switching between or within flowcharts, depending on a user's intention; and leverage domain-specific logic to guide transitions between flowcharts or skipped steps, ensuring smooth and contextually appropriate conversations in real-world scenarios.

In implementations, the dialogue system further includes a natural language understanding engine configured to interpret user inputs and intentions and mapping one or more inputs to corresponding decision nodes or action nodes within a flowchart, a synthetic data generation engine configured to create dialogues based on both happy paths and unhappy paths, where the happy paths follow a sequential structure of the flowchart and the unhappy paths simulate deviations such as skipping nodes or jumping between flowcharts or between nodes of flowcharts; and a post-processing engine configured to refine synthetic flowcharts, ensuring that only high-quality flowcharts are used for dialogue generation and training of the large language model.

Described herein is a method for training a flowchart-guided dialogue system, the method includes generating synthetic flowcharts by prompting a large language model to create directed acyclic graphs where nodes represent system actions and edges represent user responses, ensuring diversity by covering a wide range of domains and task scenarios, refining the synthetic flowcharts by removing noise and fixing structural issues, and discarding and regenerating flowcharts when necessary, generating dialogues using refined synthetic flowcharts that cover both happy paths for sequential and ideal conversations and unhappy paths for conversations where users deviate from a predefined sequence, and training the large language model using real and synthetic dialogues to enhance an ability of the large language model to manage multi-turn conversations, handling both structured and unstructured dialogue flows.

Described herein is a computer-implemented method for managing deviations from flowchart-guided dialogues, the method including detecting when a user deviates from a happy path by either skipping steps within a current flowchart or jumping to a different flowchart entirely, determining an appropriate next step using domain-specific logic, either continuing a conversation in a current flowchart or transitioning to a new flowchart based on a user's intention, and generating responses using a large language model by maintaining coherent and contextually appropriate dialogues despite deviations, using both common sense reasoning and flowchart-based constraints.

Described herein is a system for generating synthetic dialogues and flowcharts for multi-turn conversations, including a processor; and a non-transitory computer-readable storage medium storing instructions that, when executed by the processor, cause the system to: generate flowchart-based dialogue structures by prompting a large language model, synthesize flowcharts as directed acyclic graphs with decision nodes and user response edges, generate dialogues for happy paths and unhappy paths, wherein the system handles deviations by allowing skipping of nodes or switching between flowcharts, and fine-tune the large language model to manage both structured and unstructured dialogue flows.

In implementations, the non-transitory computer-readable storage medium storing further instructions that, when executed by the processor, cause the system to: generate synthetic flowcharts by prompting the large language model to create flowcharts based on diverse domains and task scenarios, post-process generated flowcharts to correct structural inconsistencies and remove low-quality scenarios; and simulate dialogue flows for various user intentions using both real and synthetic flowcharts. In implementations, the non-transitory computer-readable storage medium storing further instructions that, when executed by the processor, cause the system to: generate synthetic dialogues for happy paths, wherein the non-transitory computer-readable storage medium storing further instructions that, when executed by the processor, cause the system to: enumerate all possible dialogue paths within a flowchart, each happy path contains a sequence of decision nodes connected by user responses and ending in an action node, and generate synthetic dialogues are generated based on the happy paths to simulate ideal user-system interactions. In implementations, the non-transitory computer-readable storage medium storing further instructions that, when executed by the processor, cause the system to: generate synthetic dialogues for unhappy paths, wherein the non-transitory computer-readable storage medium storing further instructions that, when executed by the processor, cause the system to: simulate deviations from happy paths including skipping steps within a flowchart or switching between different flowcharts, and use domain-specific logic to guide the large language model's response generation for handling digressions and determining an appropriate next state in a conversation.

Described herein is a system for training a large language model to conduct flowchart-guided dialogues, including a flowchart generation engine configured to synthesize flowcharts as directed acyclic graphs for diverse task scenarios, a post-processing engine configured to refine synthetic flowcharts to ensure logical coherence and structural quality, a dialogue generation engine configured to produce synthetic dialogues for both happy paths and unhappy paths, simulating real-world scenarios such as skipped steps or topic changes, and a training engine configured to fine-tune a large language model using both real and synthetic dialogues to improve an ability to manage multi-turn conversations.

Described herein is a system for training a large language model to conduct flowchart-guided dialogues, including a large language model trained using flowchart-based dialogues, a flowchart generation engine configured to create directed acyclic graphs with decision and action nodes, a dialogue management engine configured to handle user deviations from predefined flowchart paths, including an ability to skip steps within a flowchart or switch to different flowcharts, and a decision-making module configured to apply domain-specific logic to guide conversation flow and ensure coherent dialogue management during deviations.

In implementations, the dialogue management engine further configured to detect when a user deviates from a predefined happy path, including skipped steps or jumps to a different flowchart, use domain-specific rules to determine whether to continue with a current flowchart or transition to a different flowchart, and generate appropriate system responses using the large language model to maintain a coherent and contextually relevant conversation.

Described herein is a system for generating synthetic flowcharts to improve dialogue systems, including a flowchart generation engine configured to prompt a large language model to generate directed acyclic graphs (DAGs) representing flowchart-based dialogues for various task scenarios, a post-processing engine configured to refine generated flowcharts by correcting structural errors and filtering out low-quality outputs, a dialogue generation engine configured to produce synthetic dialogues for both happy paths and unhappy paths, including scenarios where users skip steps or jump between flowcharts; and a training engine configured to fine-tune the large language model using the generated flowcharts and the synthetic dialogues, enhancing an ability to handle both structured and unstructured conversations.

While the embodiments described herein may be susceptible to various modifications and alternative forms, specific embodiments thereof are shown by way of example in the drawings and will be described in detail below. It should be understood, however that these examples not intended to limit the embodiments to the particular forms disclosed, but on the contrary, the disclosed embodiments cover all modifications, equivalents, and alternatives falling within the spirit and the scope of the disclosure as defined by the appended claims.

The method steps have been represented, wherever appropriate, by conventional symbols in the drawings, showing those specific details that are pertinent to understanding the embodiments so as not to obscure the disclosure with details that will be readily apparent to those of ordinary skill in the art having benefit of the description herein.

The terms “comprises,” “comprising,” or any other variations thereof, are intended to cover a non-exclusive inclusion, such that a process, method that comprises a list of steps does not include only those steps but may include other steps not expressly listed or inherent to such process or method. Similarly, one or more elements in a system or apparatus proceeded by “comprises . . . a” does not, without more constraints, preclude the existence of other elements or additional elements in the system or apparatus.

The features of the present embodiments are set forth with particularity in the appended claims. Each embodiment itself, together with further features and attended advantages, will become apparent from consideration of the following detailed description, taken in conjunction with the accompanying drawings.

The disclosed embodiments describe retrieving and organizing information from a set of applications, data sources, or both, by performing various steps as is described in details in forthcoming sections. For the sake explanation and understanding, reference is drawn towards a typical search query where the process heavily relies on multi-modality technology for converging speech, text, images, touch, language, and the like. Success of such a multi-modality platform mainly depends on how good and relevant the obtained results are.

Having described and illustrated the principles with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein.

Elements of the described embodiments shown in software may be implemented in hardware and vice versa. As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine-readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory. Modules can be defined by executable code stored on non-transient media.

The following description is presented to enable a person of ordinary skill in the art to make and use the embodiments and is provided in the context of the requirement for a obtaining a patent. The present description is the best presently-contemplated method for carrying out the present embodiments. Various modifications to the embodiments will be readily apparent to those skilled in the art and the generic principles of the present embodiments may be applied to other embodiments, and some features of the present embodiments may be used without the corresponding use of other features. Accordingly, the present embodiments are not intended to be limited to the embodiments shown but are to be accorded the widest scope consistent with the principles and features described herein.

What is claimed is:

1. A computer-readable storage medium storing instructions that, when executed by a processor, cause the processor to perform a method for generating synthetic dialogues and flowcharts for multi-turn conversations, comprising:
integrating flowchart-based dialogue structures into a large language model training process by including flowcharts in a prompt to instruct the large language model on governing dialogues between a system and a user based on the flowchart;
generating synthetic flowcharts by prompting the large language model to create flowcharts structured as directed acyclic graphs with nodes representing system questions and edges representing user responses, each flowchart corresponding to a specific task scenario;
post-processing generated synthetic flowcharts to reduce noise and fix structural issues, ensuring a quality and usability of the synthetic flowcharts in training;
using the synthetic flowcharts to generate dialogues for happy paths and unhappy paths, enabling the system to handle deviations from one or more predefined dialogue flows; and
enhancing common sense reasoning and decision-making capabilities in the large language model to manage multi-turn conversations by using one or more real and synthetic flowchart-based dialogues.

2. The computer-readable storage medium of claim 1, wherein the generating further comprises:
prompting the generating to generate a diverse set of flowcharts based on specific task scenarios, where each flowchart is a directed acyclic graph composed of decision nodes associated with system questions and action nodes associated with user responses;
generating a list of potential task scenarios for flowchart generation by prompting the large language model to produce domain-specific intentions, followed by manual post-processing to filter out low-quality scenarios; and
post-processing generated flowcharts to fix issues and ensure logical coherence, with flowcharts being discarded and regenerated if they require significant corrections.

3. The computer-readable storage medium of claim 1, wherein the synthetic flowcharts are used to generate dialogues for happy paths by:
enumerating all possible paths within a flowchart, each path consisting of decision nodes connected by user responses and culminating in an action node;
prompting the large language model to generate synthetic dialogues for each path, simulating ideal customer-agent interactions where the user follows a predefined flowchart sequence; and
using generated dialogues to train the large language model on conducting conversations that adhere to flowchart-based instructions.

4. The computer-readable storage medium of claim 1, wherein the synthetic flowcharts are used to generate dialogues for unhappy paths by:
simulating deviations from a happy path within the flowchart by generating dialogues where users skip nodes or jump between different flowcharts;
incorporating domain-specific logic into a dialogue generation process to guide the system's decision-making when managing user digressions from predefined flowchart paths; and
training the large language model to recognize and manage these deviations, ensuring coherent conversation flow even when the user jumps between different task scenarios or skips steps within a flowchart.

5. A method for improving large language models in conducting multi-turn dialogues based on flowcharts, the method comprising:
synthesizing flowcharts by prompting a large language model to generate directed acyclic graphs with nodes representing system questions and edges representing user responses, covering diverse domains and task scenarios;
enhancing a diversity of training data by generating synthetic flowcharts across multiple domains and refining them to ensure quality;
using generated flowcharts to simulate happy paths and unhappy paths in dialogue, where the happy paths represent ideal, sequential dialogue flows and the unhappy paths simulate real-world deviations such as skipping steps or jumping between flowcharts or between nodes of flowcharts; and
fine-tuning the large language model to manage both the happy paths and the unhappy paths based on flowchart structures, improving an ability to handle complex, real-world conversations.

6. A dialogue system comprising:
a flowchart generation engine configured to synthesize flowcharts by prompting a large language model and apply post-processing to ensure a quality of generated flowcharts before use in training and dialogue generation, where synthetic flowcharts are generated as directed acyclic graphs representing dialogue structures across a plurality of domains and task scenarios;
a large language model trained using both real and the synthetic flowcharts; and
a dialogue manager configured to:
detect user deviations from predefined happy paths and adapting a conversation by either skipping steps or switching between or within flowcharts, depending on a user's intention; and
leverage domain-specific logic to guide transitions between flowcharts or skipped steps, ensuring smooth and contextually appropriate conversations in real-world scenarios.

7. The dialogue system of claim 6, further comprising:
a natural language understanding engine configured to interpret user inputs and intentions and mapping one or more inputs to corresponding decision nodes or action nodes within a flowchart;
a synthetic data generation engine configured to create dialogues based on both happy paths and unhappy paths, where the happy paths follow a sequential structure of the flowchart and the unhappy paths simulate deviations such as skipping nodes or jumping between flowcharts or between nodes of flowcharts; and
a post-processing engine configured to refine synthetic flowcharts, ensuring that only high-quality flowcharts are used for dialogue generation and training of the large language model.

8. A method for training a flowchart-guided dialogue system, the method comprising:
generating synthetic flowcharts by prompting a large language model to create directed acyclic graphs where nodes represent system actions and edges represent user responses, ensuring diversity by covering a wide range of domains and task scenarios;
refining the synthetic flowcharts by removing noise and fixing structural issues, and discarding and regenerating flowcharts when necessary;
generating dialogues using refined synthetic flowcharts that cover both happy paths for sequential and ideal conversations and unhappy paths for conversations where users deviate from a predefined sequence; and
training the large language model using real and synthetic dialogues to enhance an ability of the large language model to manage multi-turn conversations, handling both structured and unstructured dialogue flows.

9. A computer-implemented method for managing deviations from flowchart-guided dialogues, the method comprising:
detecting when a user deviates from a happy path by either skipping steps within a current flowchart or jumping to a different flowchart entirely;
determining an appropriate next step using domain-specific logic, either continuing a conversation in a current flowchart or transitioning to a new flowchart based on a user's intention; and
generating responses using a large language model by maintaining coherent and contextually appropriate dialogues despite deviations, using both common sense reasoning and flowchart-based constraints.

10. A system for generating synthetic dialogues and flowcharts for multi-turn conversations, comprising:
a processor; and
a non-transitory computer-readable storage medium storing instructions that, when executed by the processor, cause the system to:
generate flowchart-based dialogue structures by prompting a large language model;
synthesize flowcharts as directed acyclic graphs with decision nodes and user response edges;
generate dialogues for happy paths and unhappy paths, wherein the system handles deviations by allowing skipping of nodes or switching between flowcharts; and
fine-tune the large language model to manage both structured and unstructured dialogue flows.

11. The system of claim 10, the non-transitory computer-readable storage medium storing further instructions that, when executed by the processor, cause the system to:
generate synthetic flowcharts by prompting the large language model to create flowcharts based on diverse domains and task scenarios;
post-process generated flowcharts to correct structural inconsistencies and remove low-quality scenarios; and
simulate dialogue flows for various user intentions using both real and synthetic flowcharts.

12. The system of claim 10, the non-transitory computer-readable storage medium storing further instructions that, when executed by the processor, cause the system to:
generate synthetic dialogues for happy paths, wherein the non-transitory computer-readable storage medium storing further instructions that, when executed by the processor, cause the system to:
enumerate all possible dialogue paths within a flowchart, each happy path contains a sequence of decision nodes connected by user responses and ending in an action node; and
generate synthetic dialogues are generated based on the happy paths to simulate ideal user-system interactions.

13. The system of claim 10, the non-transitory computer-readable storage medium storing further instructions that, when executed by the processor, cause the system to:
generate synthetic dialogues for unhappy paths, wherein the non-transitory computer-readable storage medium storing further instructions that, when executed by the processor, cause the system to:
simulate deviations from happy paths including skipping steps within a flowchart or switching between different flowcharts; and
use domain-specific logic to guide the large language model's response generation for handling digressions and determining an appropriate next state in a conversation.

14. A system for training a large language model to conduct flowchart-guided dialogues, comprising:
a flowchart generation engine configured to synthesize flowcharts as directed acyclic graphs for diverse task scenarios;
a post-processing engine configured to refine synthetic flowcharts to ensure logical coherence and structural quality;
a dialogue generation engine configured to produce synthetic dialogues for both happy paths and unhappy paths, simulating real-world scenarios such as skipped steps or topic changes; and
a training engine configured to fine-tune a large language model using both real and synthetic dialogues to improve an ability to manage multi-turn conversations.

15. A system for training a large language model to conduct flowchart-guided dialogues, comprising:
a large language model trained using flowchart-based dialogues;
a flowchart generation engine configured to create directed acyclic graphs with decision and action nodes;
a dialogue management engine configured to handle user deviations from predefined flowchart paths, including an ability to skip steps within a flowchart or switch to different flowcharts; and
a decision-making module configured to apply domain-specific logic to guide conversation flow and ensure coherent dialogue management during deviations.

16. The system of claim 15, the dialogue management engine further configured to:
detect when a user deviates from a predefined happy path, including skipped steps or jumps to a different flowchart;
use domain-specific rules to determine whether to continue with a current flowchart or transition to a different flowchart; and
generate appropriate system responses using the large language model to maintain a coherent and contextually relevant conversation.

17. A system for generating synthetic flowcharts to improve dialogue systems, comprising:
a flowchart generation engine configured to prompt a large language model to generate directed acyclic graphs (DAGs) representing flowchart-based dialogues for various task scenarios;
a post-processing engine configured to refine generated flowcharts by correcting structural errors and filtering out low-quality outputs;
a dialogue generation engine configured to produce synthetic dialogues for both happy paths and unhappy paths, including scenarios where users skip steps or jump between flowcharts; and
a training engine configured to fine-tune the large language model using the generated flowcharts and the synthetic dialogues, enhancing an ability to handle both structured and unstructured conversations.
